(19) United States
(12) Patent Application Publication
(10) Pub. No.: US 2018/0322601 A1
(43) Pub. Date: Nov. 8, 2018

(54) VEHICLE AUTHENTICATION SYSTEM

(71) Applicant: Ahmet Ersal Mehmet, London (GB)

(72) Inventor: Ahmet Ersal Mehmet, London (GB)

(21) Appl. No.: 15/773,203

(22) PCT Filed: Nov. 3, 2016
(86) PCT No.: PCT/EP2016/076595

§ 371 Date: May 3, 2018

(30) Foreign Application Priority Data
Nov. 3, 2015 (GB) 1519440.0

(51) Int. Cl. G06Q 50/26; G06K 7/10

(52) U.S. Cl. CPC G06Q 50/265; G06K 7/10366

(57) ABSTRACT

A vehicle authentication system for authenticating a vehicle to a registration number on a registration carrier of the vehicle, the system comprising: at least first and second wireless tags which provide respective ones of first and second authentication codes, wherein the first tag is on a body of the vehicle and the second tag is on the registration carrier of the vehicle; and an authentication device for receiving authentication codes from the vehicle and authenticating the vehicle to the registration number on the registration carrier of the vehicle as valid when receiving at least first and second authentication codes having a predetermined relationship.

The present invention relates to a vehicle authentication system for authenticating a vehicle, in particular in relation to an applied registration number.

The cloning of vehicles, that is where a false registration plate is applied to a vehicle, is becoming more widespread, and, unless a government authority, such as the police, has specific reason to believe that a registration plate is false, no action is likely to be taken.

The present inventor has devised a system whereby a registration plate can be authenticated to a vehicle, either passively where an operative is in proximity to a vehicle or actively in response to a query by an operative.

In one aspect the present invention provides a vehicle authentication system for authenticating a vehicle to a registration number on a registration carrier of the vehicle, the system comprising: at least first and second wireless tags which provide respective ones of first and second authentication codes, wherein the first tag is on a body of the vehicle and the second tag is on the registration carrier of the vehicle; and an authentication device for receiving authentication codes from the vehicle and authenticating the vehicle to the registration number on the registration carrier of the vehicle as valid when receiving at least first and second authentication codes having a predetermined relationship.

Preferred embodiments of the present invention will now be described hereinbelow by way of example with reference to the accompanying drawings:

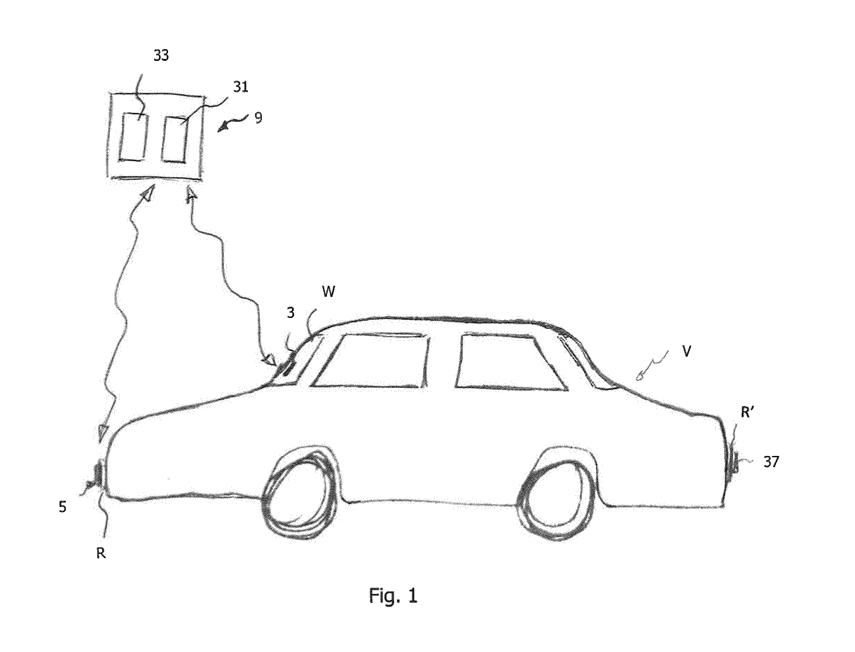

FIG. 1 illustrates a vehicle authentication system in accordance with one embodiment of the present invention; and

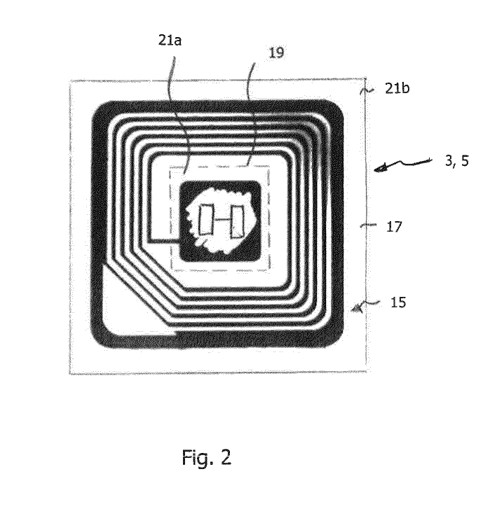

FIG. 2 illustrates the tags of the authentication system of FIG. 1.

The system comprises at least first and second wireless tags 3, 5 which provide respective ones of first and second authentication codes, and an authentication device 9 for authenticating a vehicle V based on detection of the first and second authentication codes from the tags 3, 5.

The first tag 3 is applied to the vehicle V, in this embodiment internally of the vehicle V so as not to be removable from outside of the vehicle V.

In this embodiment the first tag 3 is applied to an inner surface of the windscreen W of the vehicle V.

The second tag 5 is applied to a registration carrier R, here a registration plate, for example, a front registration plate, of the vehicle V.

In this embodiment the tags 3, 5 comprise RFID tags, but in other embodiments could comprise other forms of wireless communication, such as Bluetooth®.

In one embodiment the tags 3, 5 could be passive transponders, which transmit the respective authentication codes only on receipt of a query, in the form of an interrogating radio wave, from the authentication device 9.

In another embodiment the tags 3, 5 could be active transmitters, here powered by a battery, which transmit the respective authentication codes at intervals, such as at a given time period, for example, at 0.1, 0.5, 1, 2 or 5 s. In this embodiment the tags 3, 5 can have a range of up to about 100 m.

In this embodiment the tags 3, 5 each comprise a support 15 which is affixed to an underlying structure.

In this embodiment the support 15 is a self-adhesive element, which is configured on removal to render the system inoperative, such as to prevent subsequent tampering with the system.

In this embodiment the support 15 includes a self-adhesive panel 17 which is deformed when removed, here at a perforation 19, such as to break an electrical connection. In this embodiment the panel 17 includes sections 21a, b, here of different adhesive strength, which promote deformation of the panel 17.

In an alternative embodiment at least one of the tags 3, 5 could be integrated into a structure. For example, the second tag 5 could be embedded in a body of the registration carrier R.

The authentication device 9 comprises a receiver 31 for receiving authentication codes from the first and second tags 3, 5, and a controller 33 which authenticates the vehicle V on receipt of first and second authentication codes having a predetermined relationship, in this embodiment within a predetermined interval, for example, within a time period, such as 0.1, 0.5, 1, 2 or 5 s.

With this configuration, a registration carrier R can be determined to be false if the first and second authentication codes are not received by the authentication device 9 within the predetermined interval.

In this embodiment the authentication device 9 further comprises a transmitter 33 which transmits a query, in the form of an interrogating radio wave, to the vehicle V, in order to cause the tags 3, 5 each to transmit an authentication code.

In one embodiment the system could further comprise a third tag 37 which is applied to a second registration carrier R′, here a registration plate, for example, a rear registration plate, of the vehicle V.

In this embodiment the third tag 37 comprises an RFID tag, but in other embodiments could comprise other forms of wireless communication, such as Bluetooth®, in the same manner as the first and second tags 3, 5.

In this embodiment the receiver 31 of the authentication device 9 receives authentication codes from the first, second and third tags 3, 5, 37, and the controller 33 which authenticates the vehicle V on receipt of first, second and third authentication codes having a predetermined relationship, here within a predetermined interval, for example, within a time period, such as 0.1, 0.5, 1, 2 or 5 s.

Finally, it will be understood that the present invention has been described in its preferred embodiments and can be modified in many different ways without departing from the scope of the invention as defined by the appended claims.

1. A vehicle authentication system for authenticating a vehicle to a registration number on a registration carrier of the vehicle, the system comprising:
at least first and second wireless tags which provide respective ones of first and second authentication codes, wherein the first tag is on a body of the vehicle and the second tag is on the registration carrier of the vehicle; and
an authentication device for receiving authentication codes from the vehicle and authenticating the vehicle to the registration number on the registration carrier of the vehicle as valid when receiving at least first and second authentication codes having a predetermined relationship.

2. The system of claim 1, wherein the first tag is applied internally to the body of the vehicle so as not to be removable from outside of the vehicle.

3. The system of claim 2, wherein the first tag is applied to an inner surface of the windscreen of the vehicle,

4. The system of claim 1, wherein the tags comprise RFID tags.

5. The system of claim 1, wherein the tags comprise passive transponders, which transmit the respective authentication codes only on receipt of a query from the authentication device.

6. The system of claim 1, wherein the tags comprise active transmitters, which transmit the respective authentication codes at intervals, optionally predetermined time periods.

7. The system of claim 1, wherein at least one of the tags comprises a support which is affixed to an underlying structure.

8. The system of claim 7, wherein the support is a self-adhesive element, which is configured on removal to render the system inoperative.

9. The system of claim 8, wherein the support includes a self-adhesive panel which is deformed when removed so as to break an electrical connection.

10. The system of claim 1, wherein at least one of the tags is integrated into a structure.

11. The system of claim 10, wherein the second tag is embedded within the registration carrier of the vehicle.

12. The system of claim 1, wherein the registration carrier of the vehicle is a registration plate.

13. The system of claim 1, wherein the authentication device comprises a receiver for receiving authentication codes from the at least first and second tags, and a controller which authenticates the vehicle only when receiving the at least first and second authentication codes with the predetermined relationship.

14. The system of claim 13, wherein the authentication device further comprises a transmitter which transmits a query to the vehicle to cause the tags each to transmit an authentication code.

15. The system of claim 1, wherein the predetermined relationship between the authentication codes is a predetermined, common unique code.

16. The system of claim 1, wherein the predetermined relationship between the authentication codes is predetermined, unique codes.

17. The system of claim 1, wherein the authentication device authenticates the vehicle to the registration number on the registration carrier of the vehicle as valid only when receiving the authentication codes within a predetermined time interval.

18. The system of claim 1, further comprising:
a third tag which is applied to a second registration carrier of the vehicle.

19. The system of claim 18, wherein the third tag is embedded within the second registration carrier of the vehicle.

20. The system of claim 18 or 19, wherein the authentication device receives authentication codes from the first, second and third tags, and the controller authenticates the vehicle only on receipt of first, second and third authentication codes having the predetermined relationship.
